(19) United States
(12) Patent Application Publication
(10) Pub. No.: US 2013/0335801 A1
(43) Pub. Date: Dec. 19, 2013

(54) ELECTROCHEMICAL DEVICE HAVING ELECTRICALLY CONTROLLABLE OPTICAL AND/OR ENERGY TRANSMISSION PROPERTIES

(71) Applicants: Arnaud Verger, Paris (FR); Driss Lamine, Paris (FR); Emmanuel Valentin, Le Plessis Trevise (FR)

(72) Inventors: Arnaud Verger, Paris (FR); Driss Lamine, Paris (FR); Emmanuel Valentin, Le Plessis Trevise (FR)

(73) Assignee: SAINT-GOBAIN GLASS FRANCE, Courbevoie (FR)

(21) Appl. No.: 13/992,162

(22) PCT Filed: Dec. 5, 2011
(86) PCT No.: PCT/FR2011/052870

§ 371 Date: Aug. 26, 2013

(30) Foreign Application Priority Data
Dec. 6, 2010 (FR) 1060153

(51) Int. Cl. G02F 1/155

(52) U.S. Cl. CPC G02F 1/155
USPC 359/266; 427/77

(57) ABSTRACT

The present invention relates to an electrochemical device (1) having electrically controllable optical and/or energy properties, comprising a first electrode coating (4), a second electrode coating (12) and an electrochemically active medium (6, 10) capable of switching reversibly between a first state and a second state of different optical transmission by supplying electrical power to the first electrode coating (4) and to the second electrode coating (12),

the material of the electrode coatings being based on a metal oxide having a light transmission factor D₆₅ equal to or greater than 60%, preferably equal to or greater than 80%, and having a concentration of free charge carriers such that the material has an absorption spectrum satisfying (λ−Δλ/2)≧1.8 μm, where λ is the plasma wavelength of the material and Δλ is the full width at half maximum of the absorption spectrum at the plasma wavelength.

The present invention relates to the field of electrochemical devices having electrically controllable optical and/or energy transmission properties.

The devices involved have transmission properties that can be modified through the effect of an appropriate power supply, particularly the absorption and/or reflection in certain electromagnetic radiation wavelengths, especially in the visible and/or in the infrared. The variation in transmission generally occurs in the optical (infrared, visible, ultraviolet) range and/or in other ranges of electromagnetic radiation, hence the denomination of a device having electrically controllable optical and/or energy transmission properties, the optical range not necessarily being the sole range in question.

From the thermal standpoint, glazing whose transmission may be modulated within at least part of the solar spectrum allows the solar heat influx into rooms or passenger areas/compartments to be controlled when it is fitted as the external glazing in buildings or as windows in transportation means of the type comprising automobiles, railroad vehicles, airplanes, etc., and thus it allows excessive heating of the latter to be prevented should there be strong sunlight thereon.

From the optical standpoint, the glazing allows the degree of vision to be controlled, thereby making it possible to prevent glare when there is strong sunlight, when it is mounted as external glazing. It may also have a particularly advantageous shutter effect, both as external glazing and if it is used as internal glazing, for example for equipping internal partitions between rooms (offices in a building) or for isolating compartments in railroad vehicles or airplanes, for example.

These devices comprise two electrode coatings, one on either side of the electrochemically active medium or mediums respectively. The application of a potential across the terminals of the electrode coatings controls the variation in optical and/or energy transmission of at least one of the electrochemically active mediums.

It is difficult to obtain electrochromic layers, or more generally electrochemically active mediums, having electrically controllable optical and/or energy transmission properties without a visible optical defect on large areas (for example greater than 1 m²), the change of state of which is rapid over a wide temperature range and the contrast of which between the two states remains substantially constant over time (durability).

Cathodic electrochromic layers made of HₓWO₃, combined for example with anodic electrochromic layers made of IrOₓ or NiOₓ, have proved to be particularly promising and have been widely described in the literature.

These electrochromic layers exhibit good transparency in their transparent state and good coloration in their colored state, so that an electrochromic device, when it is incorporated into glazing, makes it possible to regulate the light transmission, that is to say the transmission of electromagnetic waves in the visible range, through the glazing.

For the purpose of regulating the light transmission, a high light transmission contrast between the two states of the device is generally desired.

Since the transmission of solar energy through the device is lower in the colored state compared with the transparent state, electrochromic devices also make it possible to adjust the heat influx (or energy transmission) through the glazing in an electrically controllable manner.

For the purpose of regulating the solar heat influx through an electrochemical device having electrically controllable optical and/or energy transmission properties, it is therefore useful to seek to improve the contrast between the solar factor g of the device in the transparent state (the solar factor g of the device corresponds to the solar energy transmittance of the device, for example defined by the standard prEN 410 of 1997) and the solar factor g in the colored state.

One object of the invention is to provide an electrochemical device having electrically controllable optical and/or energy transmission properties that has a good light transmission contrast and a good contrast in the solar factor g.

For this purpose, one subject of the present invention is an electrochemical device having electrically controllable optical and/or energy properties, of the type comprising:
a first electrode coating comprising an electroconductive layer;
a second electrode coating comprising an electroconductive layer; and
an electrochemically active medium between the first electrode coating and the second electrode coating, the electrochemically active medium being capable of switching reversibly between a first state and a second state of different optical transmission by supplying electrical power to the first electrode coating and to the second electrode coating,
   the material of at least one electroconductive layer of at least one of the first and second electrode coatings being based on a metal oxide, said material having a light transmission factor D₆₅ equal to or greater than 60%, preferably equal to or greater than 80%, in which said material has a concentration of free charge carriers such that the material has an absorption spectrum satisfying (λ−Δλ/2)≧1.8 μm, where λ is the plasma wavelength of the material and Δλ is the full width at half maximum of the absorption spectrum at the plasma wavelength.

The device according to the invention makes it possible to increase the contrast of the solar factor g of the device, by virtue of good energy transmission of electromagnetic radiation through the electrodes, while still making it possible to maintain a good light transmission contrast by virtue of a high transparency of the electrodes in the visible range, while accepting any lower conductivity of the electrodes and consequently any less-rapid change of state of the device.

One of the novel aspects of the invention stems from the fact that this object is achieved by a judicious choice of the electrodes.

Specifically, the research work on this type of device is aimed generally above all at improving the contrast in light transmission through the device.

The invention considers the possibility of obtaining a good light transmission contrast as a constraint, but is aimed most particularly at improving the contrast in energy transmission (solar factor g), that is to say at improving the contrast for the entire solar spectrum, more particularly the visible range and the near infrared.

Furthermore, to achieve this result, the invention aims to improve the energy transmission through the electrodes, having the constraint of keeping the electrodes transparent, that is to say having a good optical transmission factor in the visible (light transmission) range.

In the prior art, the electrode coatings are generally obtained by depositing one or more electroconductive layers on a substrate. These are generally inorganic layers, for example layers of metal oxides doped with a metal, and/or metallic layers.

The constraints generally taken into account for choosing the material of these electrode coatings are especially the conductivity, the transparency in the visible range, the mechanical and electrochemical stability, the ease of deposition, the cost and the durability.

It is difficult to find materials that meet all these criteria.

The device according to the invention makes it possible to obtain an excellent energy transmission of solar electromagnetic radiation through the electrodes with values of the solar factor g equal to or greater than 0.70, especially by virtue of a better optical transmission in the near infrared range (of between 0.8 and 2 μm).

The conductivity of the material of the electrodes may be lower than that of known electrodes, for example made of ITO, but this possible drawback is accepted.

It is also possible to choose a material that satisfies these properties and has excellent resistance to electrochemical corrosion liable to be caused by the active medium and the electric potential applied across the terminals of the electrodes. This is because the electrochemical device is particularly corrosive.

According to particular embodiments of the invention, the device comprises one or more of the following features, taken in isolation or according to any technically possible combination:
said material has a resistivity equal to or less than 10×10⁻⁴ Ω·cm, preferably equal to or less than 5×10⁻⁴ Ω·cm;
the mobility of the charge carriers in said material is equal to or greater than 50 cm²·V⁻¹·s⁻¹, preferably equal to or greater than 100 cm²·V⁻¹·s⁻¹;
said material has a resistivity equal to or greater than 5×10⁻⁵ Ω·cm;
the concentration of charge carriers in said material is equal to or less than 5×10²⁰ cm⁻³, for example equal to or less than 2×10²⁰ cm⁻³, for example equal to or less than 1×10²⁰ cm⁻³;
the electroconductive layer composed of said material has a thickness equal to or less than 1000 nm, preferably equal to or less than 700 nm;
the electroconductive layer composed of said material has a thickness equal to or greater than 30 nm;
said material is based on an indium zinc oxide (IZO) compound with preferably a % weight content of zinc in the IZO compound ranging between 10 and 30%;
the material is IZO;
said material is based on molybdenum-doped indium oxide (IMO), the % weight content of Mo in the IMO compound preferably ranging between 0.1% and 2.0%, preferably between 0.3% and 1.0%;
at least one of the electrode coatings comprising said material comprises a single electroconductive layer;
the first electrode coating and the electrochemically active medium are formed on the same substrate, the electrochemically active medium being a layer formed on the first electrode coating, for example an inorganic or polymer layer;
the device comprises an additional electrochemically active medium, the electrochemically active layers being placed between the two electrode coatings and separated by an electrolyte;
the device is of the all solid state type, the first electrode coating being formed on the substrate, the first electrochemically active layer being formed on the first electrode coating, the electrolyte being formed on the first electrochemically active layer, the second electrochemically active layer being formed on the electrolyte, and the second electrode coating being formed on the second electrochemically active layer;
the device comprises a counter substrate and a lamination interlayer, the counter substrate and the substrate being laminated together by means of the lamination interlayer in such a way that the electrochemically active medium is located between the substrate and the counter substrate, the lamination interlayer preferably bringing in means for electrically connecting the second electrode coating; and
the electrochemically active medium is electrochromic.

Another subject of the invention is glazing that comprises a device as described above, for example architectural glazing or automotive glazing.

Yet another subject of the invention is a process for manufacturing an electrochemical device having electrically controllable optical and/or energy properties, comprising steps of:
depositing a first electroconductive layer on a substrate in order to form a first electrode coating;
depositing a second electroconductive layer, for example on the substrate or on a counter substrate, in order to form a second electrode coating; and
depositing an electrochemically active medium intended to be located between the first electrode coating and the second electrode coating,

the electrochemically active medium being capable of switching reversibly between a first state and a second state of different optical transmission by supplying electrical power to the first electrode coating and to the second electrode coating,

in which the material of at least one electroconductive layer of at least one of the first and second electrode coatings is based on a metal oxide,

said material having a light transmission factor D₆₅ equal to or greater than 60%, preferably equal to or greater than 80%, and in which said material has a concentration of free charge carriers such that the material has an absorption spectrum satisfying (λ−Δλ/2)≧1.8 λm, where λ is the plasma wavelength of the material and Δλ is the full width at half maximum of the absorption spectrum at the plasma wavelength.

According to particular embodiments of the invention, the process has one or more of the following features, taken in isolation or according to any technically possible combination:
said material has a resistivity equal to or less than 10×10⁻⁴ Ω·cm, preferably equal to or less than 5×10⁻⁴ Ω·cm;
the mobility of the charge carriers in said material is equal to or greater than 50 cm². V⁻¹.s⁻¹, preferably equal to or greater than 100 cm². V⁻¹.s⁻¹;
said material has a resistivity equal to or greater than 5×10⁻⁵ Ω·cm;
the concentration of charge carriers in said material is equal to or less than 5×10²⁰ cm⁻³, for example equal to or less than 2×10²⁰ cm⁻³, for example equal to or less than 1×10²⁰ cm⁻³;
the electroconductive layer composed of said material has a thickness equal to or less than 1000 nm, preferably equal to or less than 700 nm;
the electroconductive layer composed of said material has a thickness equal to or greater than 30 nm;
said material is based on an indium zinc oxide (IZO) compound with preferably a % weight content of zinc in the IZO compound ranging between 10 and 30%;
the material is IZO;
said material is based on molybdenum-doped indium oxide (IMO), the % weight content of Mo in the IMO compound preferably ranging between 0.1% and 2.0%, preferably between 0.3% and 1.0%;
at least one of the electrode coatings comprising said material comprises a single electroconductive layer;
the first electrode coating and the electrochemically active medium are deposited on the same substrate, the electrochemically active medium being a layer deposited on the first electrode coating, for example an inorganic or polymer layer;
the device comprises an additional electrochemically active medium, the electrochemically active layers being placed between the two electrode coatings and separated by an electrolyte;
the device is of the all solid state type, the first electrode coating being deposited on the substrate, the first electrochemically active layer being deposited on the first electrode coating, the electrolyte being deposited on the first electrochemically active layer, the second electrochemically active layer being deposited on the electrolyte, and the second electrode coating being deposited on the second electrochemically active layer;
the device comprises a counter substrate and a lamination interlayer, the process including a step of laminating the counter substrate with the substrate by means of the lamination interlayer, this step comprising the deposition of the lamination interlayer on the second electrode coating and the deposition of the counter substrate on the lamination interlayer, and a subsequent step of heating the device to a temperature of about 100° C.; and
the electrochemically active medium is electrochromic.

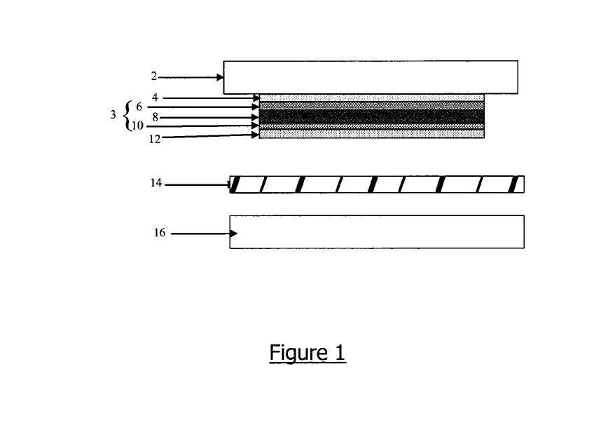

The invention will be better understood from reading the following description given solely by way of example and with reference to the appended drawing, in which FIG. 1 is a schematic cross-sectional view of an electrochemical device according to the invention.

Throughout the text, the expression “a layer A formed (or deposited) on a layer B” is understood to mean a layer A formed either directly on the layer B, and therefore in contact with the layer B, or formed on the layer B with one or more layers interposed between the layer A and the layer B.

FIG. 1 illustrates, by way of nonlimiting example, an electrochemical device 1 of electrochromic type, that is to say a device comprising at least one electrochemically active medium the light transmission of which is electrically controllable, reversibly, by supplying electrical power across the terminals of the electrode coatings with the active medium undergoing a redox reaction.

The FIGURE has not been drawn to scale, in order to provide a clear representation, since the differences in thickness between for example the substrate and the other layers are large, for example differing by a factor of around 500.

The electrochemical device described is of the all solid state type, that is to say the functional system of which is composed of layers (electrodes+active mediums) having sufficient mechanical strength to all be deposited on one and the same substrate and to adhere thereto. For this purpose, the layers of the functional system are for example inorganic or made of certain organic materials of sufficient mechanical strength, such as PEDOT.

However, in general the invention is first of all not limited to devices that act in the visible range such as electrochromic devices. As a variant, they may for example be devices acting in the infrared range (between 0.8 and 1000 μm) and not necessarily in the visible range (between 0.4 and 0.8 μm).

Next, the electrochemical device is of any suitable type and not necessarily of the all solid state type. It may for example be an organic electrochemical device, that is to say one in which the electrochemical medium is based on an organic gel or solution. It may also be a hybrid electrochemical device, that is to say one in which the electrochemical mediums are solid state layers (whether inorganic or made of polymer material) and in which the electrolyte separating the electrochemical layers is based on an organic gel or solution.

U.S. Pat. No. 5,239,406 and EP-A-0 612 826 for example describe organic electrochromic devices.

EP-0 253 713, EP-0 670 346, EP-0 382 623, EP-0 518 754 and EP-0 532 408 describe hybrid electrochromic devices.

EP-0 831 360 and WO-A-00/03290 describe all solid state electrochromic devices.

“All solid state” devices have in particular the advantage of enabling the number of substrates to be minimized.

Furthermore, the inorganic layers generally have a good durability (greater than 10 years), this being a certain advantage in a building application.

The electrochromic device 1 illustrated comprises, in the following order:
a substrate 2;
a functional system 3 comprising:
   a first electrode coating 4 formed on the substrate 2,
   a first electrochromic layer 6 formed on the first electrode coating 4,
   an electrolyte 8 formed on the first electrochromic layer 6,
   a second electrochromic layer 10 formed on the electrolyte 8 and
   a second electrode coating 12 formed on the second electrochromic layer 10;
a lamination interlayer 14 placed on the functional system 3; and
a counter substrate 16 covering the functional system and laminated to the substrate by means of the lamination interlayer 14.

The above device is a laminated electrochromic device of the all solid state type.

As a variant, the all solid state electrochromic device is not laminated. For example, the counter substrate is separated from the substrate and from the functional system by a layer of gas, for example argon.

Applying a first electric potential between the electrode coatings results in the insertion of ions, such as H⁺ or Li⁺, into the first electrochromic layer 6 and in the extraction of the ions from the second electrochromic layer 10, resulting in coloration of the functional system 3.

Application of an electric potential of opposite sign results in the extraction of the same ions from the first electrochromic layer 6 and in the insertion of the ions into the second electrochromic layer 10, leading to bleaching of the system 3.

In general, the device comprises two electrode coatings and at least one electrochemically active medium between the two electrode coatings. Applying a potential across the terminals of the electrode coatings ensures that the electrochemically active medium undergoes a redox reaction.

It should be noted that, throughout the text, the expression “electrode coating” is understood to mean a current-supplying coating comprising at least one electronically conductive layer, that is to say one in which the electrical conductivity is provided by the mobility of electrons, to be distinguished from electrical conductivity resulting from the mobility of ions.

The electrode coatings are made of a particular material. The material is based on a metal oxide and has a light transmission factor D₆₅ equal to or greater than 60% or even equal to or greater than 80%.

It should be noted that, throughout the text, the expression “light transmission factor D₆₅ of a material” is understood to mean that part of the light of an illuminant D₆₅ transmitted through the material (that is to say not absorbed by the material and not reflected at the two interfaces thereof).

Measurement of the light transmission factor D₆₅ is well known and in particular defined by the prEN 410 standard of 1997. The light distribution of an illuminant D₆₅ is that mentioned in this standard.

Furthermore, the material has a concentration of free charge carriers such that the material has an absorption spectrum satisfying (λ−Δλ/2)≧1.8 μm, where λ is the plasma wavelength of the material and Δλ is the full width at half maximum of the absorption spectrum at the plasma wavelength.

In the case of transparent conductive oxides, the plasma wavelength λ is the wavelength corresponding to the maximum absorption of solar radiation S_{λ} passing through the material (see the prEN 410 standard of 1997) in the range above 700 nm. It is this definition of the plasma wavelength that is used throughout the text.

The full width at half maximum Δ (or FWHM) is by definition the difference between the two extreme values of the independent variable for which the dependent variable is equal to half its maximum value, that is to say the distance in abscissa between the two points of the absorption spectrum on either side of the plasma wavelength that are closest to the plasma wavelength and for which the absorption is equal to 50% of the absorption at the plasma wavelength.

With an absorption spectrum such that (λ−Δλ/2)≧1.8 μm, the material greatly limits the propagation of electromagnetic waves having a wavelength in the mid and far infrared, more particularly between 2 and 100 μm.

On the other hand, the material permits the propagation of electromagnetic waves having a wavelength in the visible range (between 0.4 and 0.8 μm) and in the near infrared (between 0.8 and 2 μm).

These properties are obtained by a suitable concentration of free charge carriers in the material.

The concentration of charge carriers in the material is for example equal to or less than 5×10²⁰ cm⁻³, for example again equal to or less than 2×10²⁰ cm⁻³, again for example equal to or less than 1×10²⁰ cm⁻³.

However, the concentration of free charge carriers must be chosen appropriately to each material.

The free charge carriers in said material have a sufficient mobility so that the material has a resistivity equal to or less than 10×10⁻⁴ Ω·cm, preferably equal to or less than 5×10⁻⁴ Ω·cm.

The mobility of the charge carriers in the material is preferably equal to or greater than 50 cm²·V⁻¹·s⁻¹, preferably equal to or greater than 100 cm²·V⁻¹·s⁻¹.

This is because materials having a relatively low concentration of free charge carriers are preferential for obtaining the desired plasma wavelength even if it entails choosing materials of lower conductivity. However, among materials having a low concentration of free charge carriers, materials having a relatively high mobility of free charge carriers are preferential.

The materials listed below enable the particular absorption spectrum characteristics to be obtained.

The materials described below were obtained with a resistivity of 4×10⁻⁴ Ω·cm.

Layers having a thickness of 300 nm make it possible to obtain a sufficiently low sheet resistance for good operation of the device. A smaller thickness is possible, but the rapidity of the change of state of the device could then greatly deteriorate (assuming that the electrode coating comprises only a single electroconductive layer).

Furthermore, increasing the thickness of the layer does not decrease the light transmission factor of the layer linearly, since the light transmission factor depends on the absorption factor and on the reflection factor. The absorption factor depends on the thickness of the layer, while the reflection factor is relatively independent of the thickness of the layer.

A thickness equal to or greater than 300 nm, but not exceeding 400 nm is thus preferred.

Several materials are suitable.

The material is for example based on IZO, for example consisting of 100% IZO. Preferably, IZO has a % weight content of zinc relative to indium oxide of between 10 and 30%.

Such a material makes it possible to obtain the desired concentration of free charge carriers. The mobility of the free charge carriers is for example greater than 50 cm²·V⁻¹·s⁻¹, for example equal to or greater than 100 cm²·V⁻¹·s⁻¹.

Other possible materials are based on In₂O₃:Mo, that is to say molybdenum-doped indium oxides.

More precisely, the level of Mo doping is preferably between 0.1% and 2.0%, preferably between 0.3% and 1.0%, the material thus having a mobility of free charge carriers equal to or greater than 100 cm²·V⁻¹·s⁻¹.

In the example chosen, the second electrode coating 12 is of the same nature as the first electrode coating 4. However, it goes without saying that the materials of the electrode coatings 4 and 12 may be chosen independently and that one of them could for example be chosen from conventionally used materials, such as ITO and SnO₂:F.

As regards an “all solid state” multilayer in the example illustrated, the second electrode coating 12 is deposited on the second electrochromic layer 10.

The other elements of the device 1 will be described below for an embodiment example of the invention.

The material of the first electrochromic layer 6 inserts ions during extraction of ions from the second electrochromic layer 10, and extracts ions during insertion of ions into the second electrochromic layer 10.

The first electrochromic layer 6 is for example of the anodic type, whereas the second electrochromic layer 10 is of the cathodic type, in such a way that the materials can become colored and bleached simultaneously during ion insertion/extraction.

The material of the first electrochromic layer 6 is for example chosen from HₓIrO_{y} or HₓNiO_{y}, that is to say a hydrated iridium oxide or a hydrated nickel oxide.

The first electrochromic layer 6 is deposited here on the electrode coating 4, which is always the case for “all solid state” or “hybrid” electrochromic devices.

The material of the second electrochromic layer 10, when this is a cathodic coloration electrochromic material, is for example HₓWO₃, that is to say a hydrated tungsten oxide.

In the case of an “all solid state” device, the second electrochromic layer is deposited here on the electrolyte 8.

However, as a variant, the device is of the “hybrid” type and the second electrochromic layer 10 is formed on the counter substrate 16, with the second electrode coating 12.

The layers 6 and 10 given in the above example act by varying the absorption factor.

As a variant, the electrochromic layer 6 and/or the electrochromic layer 10 are made of an electrochromic material that acts by varying the reflection factor. In this case, at least one of the layers is based on rare earths (yttrium or lanthanum), or an alloy of magnesium Mg and transition metals, or a semimetal (such as antimony Sb, possibly doped with for example cobalt Co, manganese Mn, etc.), while the other layer may be an electrochromic layer that acts by varying the absorption factor as above (for example WO₃) or simply a nonelectrochromic ion storage layer.

Furthermore, one of the two electrochromic layers 6 and 10 is not necessarily electrochromic, that is to say it does not necessarily provide a significant optical variation effect. In general, in the case of an electrochromic system, there is an electrochromic layer and an ion storage layer, for storing insertion ions, which ion storage layer is optionally electrochromic. An example of a nonelectrochromic ion storage material is CeO₂ (cerium oxide).

The electrolyte layer 8 is made of a material of any suitable type for ensuring the mobility of the insertion ions, while still being electronically insulating.

This may for example be a layer of Ta₂O₅ having a thickness of between 1 nm and 1 micron, for example between 100 nm and 400 nm.

As a variant, the electrolyte 8 comprises a plurality of layers, for example a layer based on tantalum oxide and a layer based on tungsten oxide on the side of the anodic electrochromic layer.

The insertion ions are for example H⁺ in the case of the electrochromic layers indicated above. As a variant these may be Li⁺ or Na⁺ or K⁺ ions, or other alkali metal ions, in the case of electrochromic systems.

Also as a variant, the electrochemical device 2 is of the all organic type. In this case, the substrate and the counter substrate are provided only with electrode coatings 4 and 12. The active medium is located between the two electrode coatings and is in contact with the two electrode coatings.

The active medium is for example an electrochromic solution or gel.

Whatever the electrochemically active medium—whether all solid state or organic—the substrate 2 is, in particular in the case of glazing, a sheet having a glass function.

The sheet may be flat or curved and have any dimensions, especially at least one dimension greater than 1 meter.

Advantageously, this is a sheet of glass.

The glass is preferably of the soda-lime-silica type, but other types of glass, such as borosilicate glass, may also be used. The glass may be clear or extra-clear, or else tinted, for example tinted blue, green, amber, bronze or gray.

The thickness of the glass sheet is typically between 0.5 and 19 mm, especially between 2 and 12 mm, for example between 4 and 8 mm. The glass may also be a glass film with a thickness equal to or greater than 50 μm (in this case, the EC multilayer and the TCO/TCC electrode coatings are deposited for example by the roll-to-roll process).

As a variant, the substrate 2 is made of a flexible transparent material, for example a plastic.

A lamination interlayer 14 provided with electrical connection means, such as wires, is then applied to the substrate 2 after the layers 4 to 12 have been deposited. The lamination interlayer 14 is for example made of PU (polyurethane). This provides the adhesion between the substrate 2 and the counter substrate 16 so as to obtain laminated glazing.

It goes without saying that the lamination interlayer is not essential for protecting the electrochromic layers, and may be absent. The counter substrate 16 is then advantageously spaced away from the functional system 3 and an interlayer gas fills the space between the substrate 4 and the counter substrate 16.

Especially in the case of glazing, the counter substrate 16 is a sheet having a glass function.

The sheet may be flat or curved and have any dimensions, especially at least one dimension greater than 1 meter.

Advantageously, this is a sheet of glass.

The glass is preferably of the soda-lime-silica type, but other types of glass, such as borosilicate glass, may also be used. The glass may be clear or extra-clear, or else tinted, for example tinted blue, green, amber, bronze or gray.

The thickness of the glass sheet is typically between 0.5 and 19 mm, especially between 2 and 12 mm, for example between 4 and 8 mm. The glass may also be a glass film with a thickness equal to or greater than 50 μm (in this case, the EC multilayer and the TCO/TCC electrode coatings are deposited for example by the roll-to-roll process).

As a variant, the counter substrate 16 is made of a flexible transparent material, for example a plastic.

The subject of the invention is not only the device 1 described above, but also glazing that comprises the device 1. This may for example be architectural multiple glazing, which for example includes laminated glazing, or else single laminated glazing for automobiles.

It should be noted that the expression “multiple glazing” is understood to mean an assembly comprising a plurality of glazing panes spaced apart and separated by gas interlayers.

In fact the device 1 has the advantage of having a delamination resistance sufficiently high, owing to the choice of material of the layers, to be incorporated into laminated glazing and even into curved glazing.

The subject of the invention is also a process for manufacturing the device 1.

The process comprises, in the case of an “all solid state” device, steps of:

depositing the first electrode coating 4 on the substrate 2;
depositing the first electrochromic layer 6 on the first electrode coating 4;
depositing the electrolyte 8 on the first electrochromic layer 6;
depositing the second electrochromic layer 10 on the electrolyte 8; and
depositing the second electrode coating 12 on the second electrochromic layer 10.

As a variant, one of the electrochromic layers does not become colored but merely plays an ion storage role.

In the case of a hybrid device, the first electrode coating 4 and the first electrochromic layer 6 are deposited on the substrate 2, whereas the second electrode coating 12 and the second electrochromic layer 10 are deposited on the counter substrate 16. The electrolyte 8 is then placed between the substrate 4 and the counter substrate 16.

In the case of an “all organic” electrochromic device, the electrochromic layers and the electrolyte are replaced with a solution or gel that contains active species which become colored under the effect of electrical power supplied to the electrodes.

Furthermore, more generally, as explained above, the invention is not limited to electrochromic devices but extends to any electrochemical device that includes an electrochemically active medium capable of switching reversibly between two states of different optical transmission through a redox reaction.

The invention is therefore not limited to devices acting in the visible range such as electrochromic devices, but also extends to devices having variable optical properties only in the infrared range.

Thus, in general, the process therefore comprises steps of:
depositing an electrode coating (4, 12) on the substrate 2; and
placing at least one electrochemically active medium capable of switching reversibly between two states of different optical transmission in contact with the electrode coating (4, 12).

The material of the electrode coating (4, 12) is preferably deposited by magnetron sputtering.

Preferably, but not necessarily, all the solid layers are deposited by magnetron sputtering in order to optimize the production means.

### EMBODIMENT EXAMPLE

The following multilayer may be produced on a clear soda-lime-silica glass substrate 2 having a thickness of 2.1 mm:
a 300 nm thick InMoO layer doped with 5 wt % Mo, deposited by magnetron sputtering in an oxygen-enriched atmosphere at a temperature of 300° C. and a pressure of 0.4 Pa;
a 90 nm thick IrOₓ layer obtained by magnetron sputtering under the same deposition conditions;
a 250 nm thick Ta₂O₅ layer obtained by magnetron sputtering under the same deposition conditions;
a 300 nm thick hydrated WO₃ layer obtained by magnetron sputtering under the same deposition conditions; and
a 300 nm thick InMoO layer doped with 1 wt % Mo, deposited by magnetron sputtering in an oxygen-enriched atmosphere at a temperature of 300° C. and a pressure of 0.4 Pa.

A lamination interlayer 14, for example a 0.76 mm thick PU interlayer provided with electrical connection means, may then be applied, together with a clear soda-lime-silica glass counter substrate 16 2.1 mm in thickness, which are heated to 100° C. for carrying out the lamination.

### ITO/IMO Comparison

Table 1 below compares the performance of a first electroconductive layer formed from 300 nm of ITO with a first electroconductive layer formed from 300 nm of IMO.

The IMO layer is a 300 nm thick In₂O₃:Mo layer doped with 1.0 wt % Mo, deposited by magnetron sputtering in an oxygen-enriched atmosphere. The ITO layer is a 300 nm thick In₂O₃ layer doped with 10 at % Sn, deposited by magnetron sputtering in an oxygen-enriched atmosphere.

TABLE 1

| | | | Charge | |
|---|---|---|---|---|
| | | | carrier | |
| | Resistivity | Mobility | concentration | Solar |
| Compound | (Ω · cm) | (cm² · V⁻¹ · s⁻¹) | (cm⁻³) | factor g |
| ITO | 1.88 × 10⁻⁴ | 40 | 9 × 10²⁰ | 0.66 |
| IMO | 4 × 10⁻⁴ | 150 | 1 × 10²⁰ | 0.75 |

The results illustrate the advantages discussed above, namely a better solar factor g of the IMO conductive layer than that of ITO, but a higher resistivity. The concentration of free charge carriers is in fact much lower than in the case of ITO. This low concentration is partly compensated for by a greater mobility of the charge carriers.

It should be noted that, throughout the text, the expression “solar factor g of a material” is understood to mean that part of the solar radiation S_{λ} transmitted through the material and that part of the solar radiation S_{λ} absorbed by the material and re-emitted to the inside (on the side opposite the side on which the solar radiation is incident), the solar radiation Sₓ being incident on that side of the device which is intended to be placed facing the solar light.

The measurement of the solar factor g is well known and especially defined by the prEN 410 standard of 1997. The spectral distribution of an illuminant S_{λ} is mentioned in that standard.

The electrodes also exhibit good transparency, good mechanical stability (delamination resistance) and good electrochemical stability (corrosion resistance).

1. An electrochemical device having electrically controllable optical and/or energy properties, comprising:
a first electrode coating comprising an electroconductive layer;
a second electrode coating comprising an electroconductive layer; and
an electrochemically active medium between the first electrode coating and the second electrode coating, wherein the electrochemically active medium is capable of switching reversibly between a first state and a second state of different optical transmission by supplying electrical power to the first electrode coating and to the second electrode coating,
wherein the material of at least one electroconductive layer of at least one of the first and second electrode coatings comprises a metal oxide, said material having a light transmission factor D₆₅ equal to or greater than 60%, wherein said material has a concentration of free charge carriers such that the material has an absorption spectrum satisfying (λ−Δλ/2)≧1.8 μm, wherein λ is the plasma wavelength of the material and Δλ is the full width at half maximum of the absorption spectrum at the plasma wavelength, the electrochemically active medium being active at this plasma wavelength for a solar factor contrast g.

2. The device of claim 1, wherein said material has a resistivity equal to or less than 10×10⁻⁴ Ω·cm.

3. The device of claim 1, in wherein the mobility of the charge carriers in said material is equal to or greater than 50 cm²·V⁻¹·s⁻¹.

4. The device of claim 1, wherein said material has a resistivity equal to or greater than 5×10⁻⁵ Ω·cm.

5. The device of claim 1, wherein the concentration of charge carriers in said material is equal to or less than 5×10²⁰ cm⁻³.

6. The device of claim 1, wherein the electroconductive layer composed of said material has a thickness equal to or less than 1000 nm.

7. The device of claim 1, wherein the electroconductive layer composed of said material has a thickness equal to or greater than 30 nm.

8. The device of claim 1, wherein said material comprises an indium zinc oxide (IZO) compound having a % weight content of zinc in the IZO compound ranging from 10 to 30%.

9. The device of claim 8, wherein the material is IZO.

10. The device of claim 1, wherein said material comprises molybdenum-doped indium oxide (IMO), wherein the % weight content of Mo in the IMO compound is in a range from 0.1% to 2.0%.

11. The device of claim 1, wherein at least one of the electrode coatings comprising said material comprises a single electroconductive layer.

12. The device of claim 1, wherein the first electrode coating and the electrochemically active medium are formed on the same substrate, and wherein the electrochemically active medium is a layer formed on the first electrode coating.

13. The device of claim 12, further comprising an additional electrochemically active medium, wherein the electrochemically active layers are placed between the two electrode coatings and separated by an electrolyte.

14. The device of claim 13, in which wherein the device is of the all solid state type, the first electrode coating is formed on the substrate, the first electrochemically active layer is formed on the first electrode coating, the electrolyte is formed on the first electrochemically active layer, the second electrochemically active layer is formed on the electrolyte, and the second electrode coating is formed on the second electrochemically active layer.

15. The device of claim 14, further comprising a counter substrate and a lamination interlayer, wherein the counter substrate and the substrate are laminated together with the lamination interlayer such that the electrochemically active medium is located between the substrate and the counter substrate.

16. The device of claim 1, wherein the electrochemically active medium is electrochromic.

17. A process for manufacturing an electrochemical device having electrically controllable optical and/or energy properties, the process comprising:
depositing a first electroconductive layer on a substrate to form a first electrode coating;
depositing a second electroconductive layer, on the substrate or on a counter substrate, to form a second electrode coating; and
depositing an electrochemically active medium intended to be located between the first electrode coating and the second electrode coating,
wherein the electrochemically active medium is capable of switching reversibly between a first state and a second state of different optical transmission by supplying electrical power to the first electrode coating and to the second electrode coating,
wherein the material of at least one electroconductive layer of at least one of the first and second electrode coatings comprises a metal oxide, and
wherein said material has a light transmission factor D₆₅ equal to or greater than 60%, and has a concentration of free charge carriers such that the material has an absorption spectrum satisfying (λ−Δλ/2)≧1.8 μm, wherein λ is the plasma wavelength of the material and Δλ is the full width at half maximum of the absorption spectrum at the plasma wavelength.

18. The device of claim 1, wherein said material has a resistivity equal to or less than 5×10⁴ Ω·cm.

19. The device of claim 1, wherein the mobility of the charge carriers in said material is equal to or greater than 100 cm²·V⁻¹·s⁻¹.

20. The device of claim 1, wherein the concentration of charge carriers in said material is equal to or less than 2×10²⁰ cm⁻³.
